(19) United States
(12) Patent Application Publication
(10) Pub. No.: US 2013/0037378 A1
(43) Pub. Date: Feb. 14, 2013

(54) PALLETISER ENTRY STATION

(71) Applicants: Dominique Germain, Octeville-sur-Mer (FR); Fabrice Sauvageot, Octeville-sur-Mer (FR)

(72) Inventors: Dominique Germain, Octeville-sur-Mer (FR); Fabrice Sauvageot, Octeville-sur-Mer (FR)

(73) Assignee: SIDEL PARTICIPATIONS, Octeville-sur-Mer (FR)

(21) Appl. No.: 13/642,595

(22) PCT Filed: May 2, 2011
(86) PCT No.: PCT/FR11/50989

§ 371 Date: Oct. 22, 2012

(30) Foreign Application Priority Data
May 6, 2010 (JP) 10 53526

(51) Int. Cl. B65B 35/56; B65G 47/88; B65G 47/244; B65B 59/02; B65G 21/20

(52) U.S. Cl. 198/373

(57) ABSTRACT

The invention relates to an entry station (1) which comprises at least one passageway for parallelepiped packages, located upstream from the preparation station (3), said passageway (6) being defined by means of lateral rails (7, 8) which are separated by a distance substantially corresponding to the length of said packages (2) and comprising a means for varying the width thereof at the pivoting area of said packages (2). The passageway (6) is defined by a rail (7) which is aligned with the pivoting abutment (15), and a rail (8) located opposite, facing the former, said opposite rail (8) including, in the downstream portion thereof, in the pivoting area, a rail section (14) that extends as far as the entrance to the preparation station (3) and said section can be retracted in order to allow the pivoting of the package (2) halted by said abutment (15) at said pivoting area.

The invention relates to the field of palletisers, and in particular to an entry station comprising one or more passageways for bringing parallelepiped packages such as packs or cardboard boxes to the preparation table where rows or groups of packages are prepared.

Document FR 2 896 230 shows a palletiser arranged to improve the operation of grouping and preparing rows of packages, and packs in particular, in order to form a layer of packs for subsequent transport by a palletisation table to a station where the layer is placed on a pallet.

The present invention relates to an improvement to the portion located upstream from this preparation station for preparing groups and rows of packages, said portion possibly comprising one or more passageways for supplying said packages.

The present invention particularly relates to the terminal area of this or these passageways and in particular the area which comprises means for modifying the orientation of the packages by rotating them 90° before their introduction to the station for preparing these rows or groups of packages.

Document U.S. Pat. No. 4,085,839 shows a conveyance system arranged to modify the orientation of parallelepiped packages having a rectangular horizontal cross-section, by rotating them precisely 90° on a vertical axis. The packages arrive on a conveyor belt, in a passageway having a width corresponding to at least their length and, at the end of this entry passageway, a fixed lateral abutment referred to as a bumper causes the packages to pivot as they are moved along by the conveyor belt. The exit passageway for the packages, after the bumper, has a width which corresponds to that of the packages and consists of two continuous conveyor belts on the sides which position the packages longitudinally.

This type of installation systematically orients all packages as they arrive. The invention proposes an installation which selectively orients the parallelepiped packages which arrive crosswise; this orientation is performed as needed and more particularly as a function of the pallet pattern.

For parallelepiped packages that are packs of small dimensions, it is important to guide them for as long as possible because of their relative instability on conveyors and in particular on roller conveyors which are used in this entrance area as well as at the preparation station for preparing rows or groups of packs. Packs have a tendency to “dance” on these conveyors and assume random positions or orientations which hinder the subsequent formation of groups or rows of these packs at the preparation station.

The invention proposes an arrangement of the palletiser entry station which provides optimized guidance for these parallelepiped packages over a maximized distance, in particular in the pivoting area and even beyond it, meaning up to the area where they are introduced into the preparation station for preparing groups or rows of packages, said introduction area being delimited by an imaginary barrier which corresponds to the passage of the upper edge of the pusher which takes the groups or rows of packages at this preparation station and moves them to the next station of the palletiser where the layer of packages is formed before the actual palletisation operation.

The rest of the description of the invention will often refer to one passageway, although the arrangements described for one passageway are valid for the other passageway or passageways if such exist. Similarly, although the description refers to packs, here again the arrangements made to improve the guidance of packs are suitable for guiding any type of packaging.

The palletiser entry station is placed upstream from the preparation station for preparing groups or rows of packages, and comprises at least one passageway which supplies packages to said preparation station, said passageway being delimited by side rails spaced apart by a distance substantially corresponding to the length of said packages. In the invention, this passageway comprises a rail positioned in alignment with the abutment that acts when needed to pivot said packages, and this passageway comprises means for varying its width in the area where said packages are pivoted, said means being applied automatically and simultaneously with said pivoting abutment when the latter is placed in the active position to cause a package to pivot, under the control of a programmable logic controller for example.

Still according to the invention, the passageway is delimited by two guide rails:—the rail positioned in alignment with the pivoting abutment, and—a rail positioned opposite and facing said rail, said opposite rail comprising in its downstream portion, in the pivoting area, a rail section that extends as far as the entrance to the preparation station for preparing the rows of packages and is supported by a mechanism which allows moving it transversely and retracting it to allow the pivoting of the package halted by said abutment, in said pivoting area, said movement of said section establishing a width for said passageway which is at least equal to the diagonal of the package.

In another arrangement of the invention, in the case of an entry station which comprises two passageways for packages, the pivoting abutments are arranged in alignment with the rails of the central portion, between the two passageways, and they are longitudinally offset relative to each other and spaced apart by rail sections arranged in the extension of said rails from said central portion, said rail sections being fixed and extending the package guidance in the pivoting area, for each of the two passageways.

The retractable outside rail or rails allow extending the package guidance as far as the entrance to the preparation station for preparing the groups or rows of packages on the palletiser and in particular to the pusher action area where the pusher takes said groups or rows of packages to transfer them to the palletisation layer preparation table.

Still according to the invention, the movable rail section or sections, which are transversely retractable, are guided by a slide system integrally attached to a transverse beam extending above the passageways, each of these movable rail sections being maneuvered by means of an actuator device controlled by the programmable logic controller, simultaneously with the application of the pivoting abutment or abutments, said actuator being, for example, adjustably attached to said transverse beam in order to adapt to different package sizes.

In another arrangement of the invention, the transverse beam supports the slide systems for guiding the retractable rail sections and also supports the rail sections arranged between the pivoting abutments, said abutments themselves being supported and guided by said transverse beam, each maneuvered by an actuator device controlled by means of the programmable logic controller.

The invention is detailed in a sufficiently clear and complete manner in the following description to enable its execution, additionally accompanied by drawings in which:

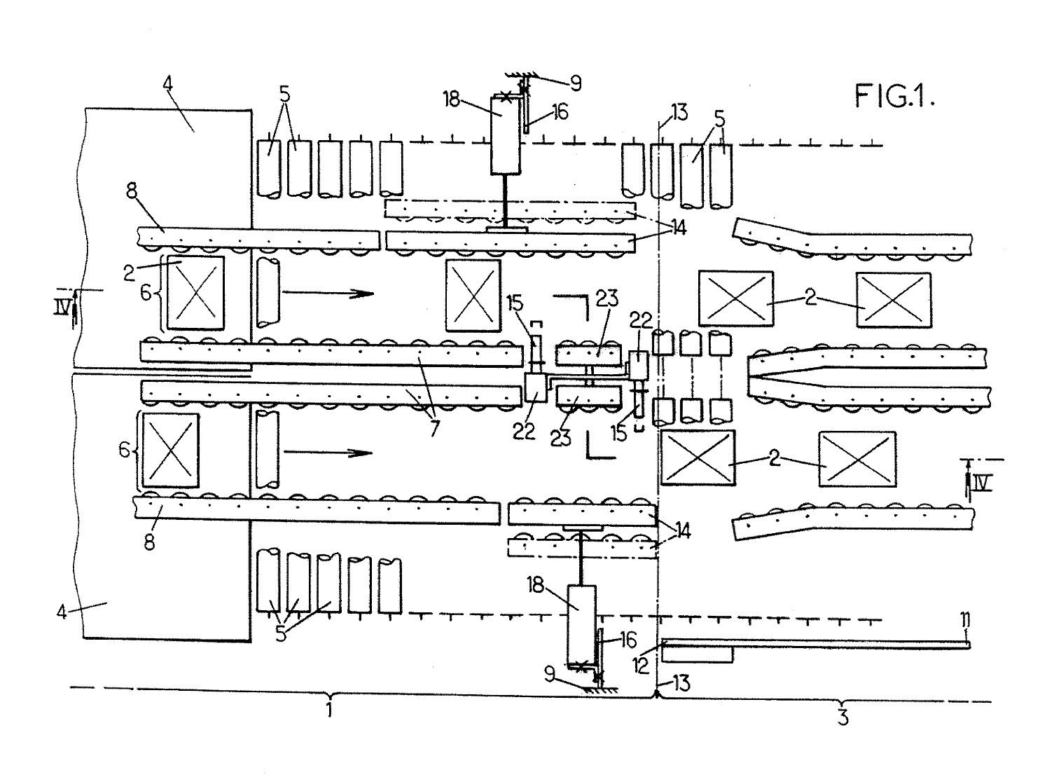

FIG. 1 is a partial schematic plan view of a palletiser with an entry station comprising two passageways for packages, said passageways being located upstream from the preparation station for preparing groups or rows of packages;

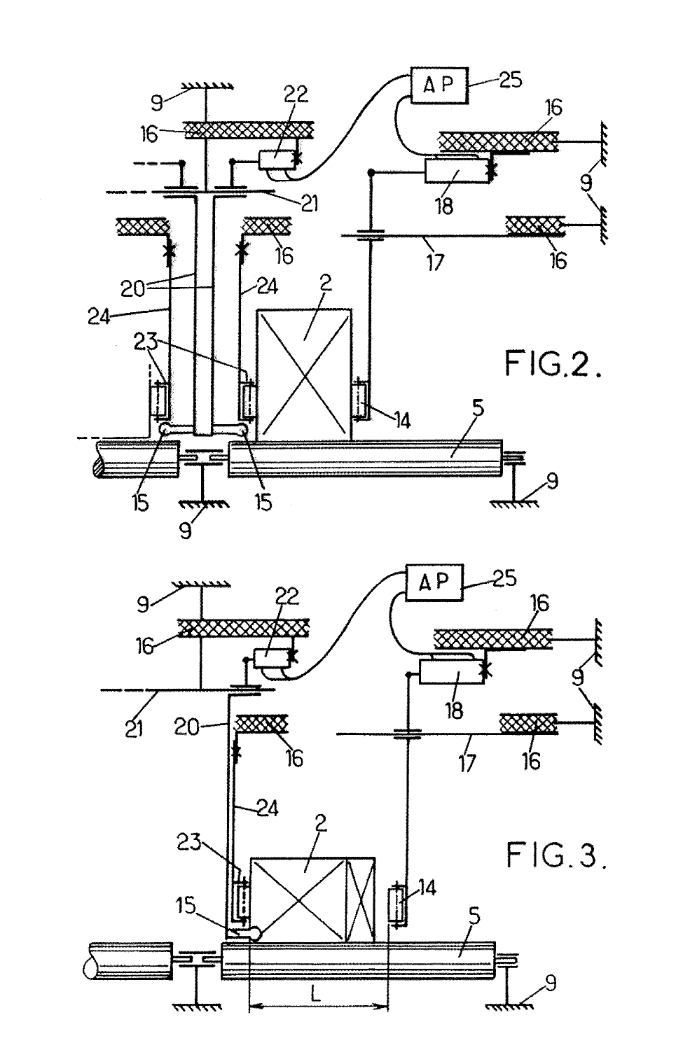

FIG. 2 is a front elevation diagram showing a half-view of the entry station with a passageway for packages, said passageway being in a normal configuration for guiding a package arranged transversely;

FIG. 3 is an elevation diagram similar to FIG. 2, showing a package during its rotation due to the effect of the pivoting abutment which is in the active position to force said package to pivot a quarter turn;

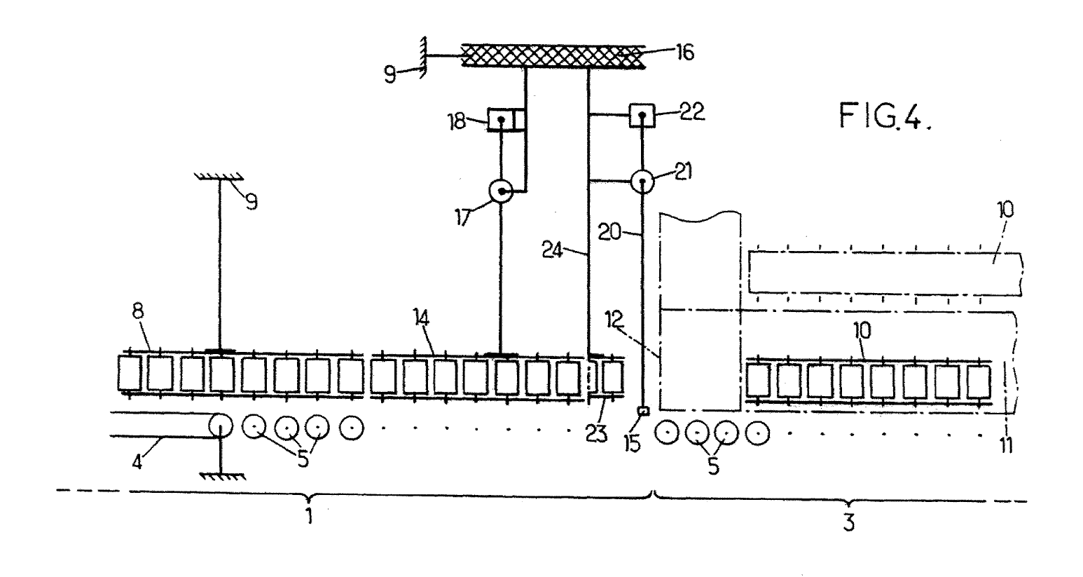

FIG. 4 is an elevation diagram showing a side view of the entry station and the upstream portion of the preparation station for preparing groups or rows of packages, on the palletiser.

FIG. 1 shows the downstream portion of an entry station 1 for packages 2 that are boxes or packs, and the upstream portion of a preparation station 3 for preparing groups or rows of these packages 2.

This entry station 1 comprises conveyors, and in particular a conveyor 4 referred to as a separation conveyor which creates spacing between the packages 2, said separation conveyor 4 consisting for example of a continuous conveyor belt.

This separation conveyor 4 is followed by a motorized roller conveyor 5, driven by appropriate means, and this roller conveyor 5 extends, still with rollers, into the preparation station 3 which acts as a table.

The packages 2 are guided in passageways 6 which are delimited by side rails 7 and 8. The rails 7 are fixed, integrally attached to the general frame 9, and the rails 8 are transversely adjustable to allow adapting the width of the passageways 6 to the dimensions of the packages 2.

The preparation station 3 also comprises rails 10 which delimit passageways to accept the packages 2 which arrive either transversely or longitudinally, depending on the pallet pattern.

At this preparation station 3, the packages 2 are grouped into rows before being moved by a pusher 11 of the type described in the abovementioned document FR 2 896 230.

The passageways 6 extend to the edge of the area which the edge 12 of the pusher 11 passes across, so as to guide the packages 2 for as great a distance as possible, especially for packages 2 such as packs of small dimensions which are particularly unstable on roller conveyors 5.

The edge of the pusher 11 passage area is indicated in FIG. 1 by a dashed and dotted line 13 marking the end of the entry station 1 and the start of the preparation station 3 for preparing groups and rows of packages, said edge corresponding to the area swept by the upstream edge 12 of the pusher 11 when it takes the groups or rows of packages to move them to the package layer preparation station, not shown.

In the case of an installation such as the one represented in FIG. 1, with a pair of passageways 6, the outside rails 8 comprise a retractable section 14 at their downstream end which is transversely movable to increase the width of the passageway.

These segments 14 are situated in the package 2 pivoting area, said pivoting being achieved by means of abutments 15 supported by a beam 16 integrally attached to the frame 9; this beam 16 is placed transversely above the passageways 6.

The abutments 15 are transversely movable to allow their entry into each corresponding passageway 6; they then prevent the passage of packages 2 and force them to pivot a quarter turn on a vertical axis.

Because the packages 2 are guided in a passageway 6 of a width corresponding to their dimensions and in particular their length, pivoting these packages 2 is only made possible by retracting section 14 of the rail 8, which is situated in the pivoting area, to increase the width of said corresponding passageway 6 to a value which corresponds to at least the length of the diagonal of said packages 2.

As represented in FIGS. 2 to 4, the section 14 of each rail 8 is supported by a beam 16; it is guided on this beam 16 by means of a slide system 17, and is maneuvered by means of an actuating device 18 which is also anchored on said beam 16 in a manner that allows adjusting it to different sizes of packages 2.

In FIG. 4, one will also note the abutment 15 is supported by a pole 20. Said pole 20 is guided on the beam 16 by a slide system 21 and is maneuvered by means of an actuator device 22 which is also supported by the beam 16.

The pivoting abutments 15 are spaced apart longitudinally and the space between these abutments contains rail sections 23 which extend the rails 7 placed in the center. These fixed rail sections 23 are supported by the beam 16 by means of a pole 24.

The actuator device 22 serving to maneuver the abutment 15, and the actuator device 18 serving to maneuver the rail section 14, are controlled by a programmable logic controller 25, FIGS. 2 and 3. This controller 25 takes into account the characteristics of the packages 2 as they arrive, by appropriate capture means that are not represented, and it controls the actuation of said maneuvering devices 22 and 18 as a function of the pallet pattern to change said packages 2 from their sideways orientation to a longitudinal orientation, as represented in FIG. 1.

FIG. 3 shows the abutment 15 in the active position which causes a package 2 to pivot. Placing the abutment 15 in the active position automatically triggers the retraction of the rail section 14, leaving the package 2 free to make its quarter turn in the pivoting area and continue to advance towards the preparation station for grouping and preparing rows or groups of packages 2.

As represented in this FIG. 3, the distance L between the rail section 14 and the rail section 23 is greater than the length of the diagonal of the package 2.

This arrangement of the entry station 1 improves the efficiency of palletisers of the type described in the abovementioned document FR 2 896 230, establishing a cooperation between the entry station 1 and the preparation station 3 for preparing layers or rows of package 2, as shown in FIG. 4 where dashed and dotted lines represent the pusher 11 as well as the rails 10 when they are in the retracted position to allow the passage of said pusher 11.

1-6. (canceled)

7. An entry station for a palletiser, comprising at least one passageway for packages, said entry station being situated upstream from a preparation station for preparing packages, said at least one passageway being delimited by side rails spaced apart by a distance substantially corresponding to a length of said packages, wherein said at least one passageway comprises a first side rail positioned in alignment with a pivoting abutment which acts when needed to pivot said packages by 90°, and wherein said at least one passageway comprises a width varying mechanism for varying the width of said at least one passageway in a pivoting area where the packages are pivoted, said width varying mechanism being applied automatically and simultaneously with said pivoting abutment when said pivoting abutment is placed in an active position to cause a package to pivot, and said width varying mechanism and pivoting abutment are controlled by a programmable logic controller.

8. The entry station for a palletiser according to claim 7, wherein said at least one passageway—further comprises a second side rail which is positioned opposite and facing said first side rail, said second side rail having a downstream portion, in said pivoting area, comprising a second rail section that extends as far as an entrance to the preparation station for preparing rows and/or layers of packages, and said second rail section is supported by said width varying mechanism which allows moving said second rail section transversely and retracting said second rail section to allow the pivoting of the package halted by said pivoting abutment, in said pivoting area, the movement of said second rail section establishing a width for said at least one passageway which is at least equal to the diagonal of the package.

9. The entry station for a palletiser according to claim 7, comprising two adjacent passageways for packages, said passageways each comprising one respectively of two pivoting abutments, each of which is arranged in alignment with a respective one of two first side rails of a central portion, between said passageways, said pivoting abutments being longitudinally offset relative to each other and spaced apart by two first rail sections each of which is arranged in the extension of a respective one of said first side rails from said central portion, said first rail sections being fixed and extending the package guidance in said pivoting area, for said two passageways.

10. The entry station for a palletiser according to claim 8, wherein said transversely retractable second rail section is guided by a slide system integrally attached to a transverse beam extending above said at least one passageway, said second rail section being maneuvered by an actuator device controlled by said programmable logic controller, simultaneously with the application of said pivoting abutment maneuvered by another actuator device controlled by said logic controller.

11. The entry station for a palletiser according to claim 10, wherein said actuator device is adjustably attached to said transverse beam in order to adapt to different sizes of packages.

12. The entry station for a palletiser according to claim 10, wherein said transverse beam supports said slide system for guiding said second rail section and also supports a first rail section arranged in the extension of said first side rail, said pivoting abutment being also supported and guided by said transverse beam.
